(19) United States
(12) Patent Application Publication
(10) Pub. No.: US 2002/0022895 A1
(43) Pub. Date: Feb. 21, 2002

(54) System configuration editor with an iconic function sequencer

(76) Inventors: Ronald G. Genise, Raleigh, NC (US); Foster J. Salotti IV, Willow Springs, NC (US); Francois M. Seguin, Ruttenen (CH)

Correspondence Address: David B. Ritchie, Thelen Reid & Priest LLP, P.O. Box 640640, San Jose, CA, 95164-0640, US

(21) Appl. No.: 09/800,940

(22) Filed: Mar. 6, 2001

Related U.S. Application Data
(60) Provisional application No. 60/188,559, filed on Mar. 10, 2000.

(51) Int. Cl. G05B 15/00

(52) U.S. Cl. 700/83; 700/15; 345/967

(57) ABSTRACT

A graphical user interface (GUI) includes a system configuration editor for configuring a machine control system and an iconic function sequencer for ordering the execution of functional processes within the machine control system. The system configuration editor graphically reflects how logical functions are connected to electrical functions within the physical machine system and permits a user to set up and alter those connections. Logical function blocks include one or more software program objects that perform logical functions such as dispensing a component in a pick and place machine control system. The system configuration editor permits configuring a logical function to use various electrical functions in performing its programmed function. For example, a user can electrically configure a logical dispensing function to turn on motor #3 and access output #2 from module #4 through graphical connections made between logical and electrical functions using the visual configuration editor. After the logical function blocks are configured in the machine control system, the iconic function sequencer permits a user to select the function blocks as tools and build a graphical representation of the sequence in which they will be performed. A user can click on and grab copies of each tool and connect compatible tools together in a building area on the screen, thus determining which logical functions will be performed and in what order they will be performed.

### RELATED APPLICATIONS

This application claims the benefit of provisional U.S. patent application Ser. No. 60/188559 filed on Mar. 10, 2000 in the names of Ronald G. Genise and Foster J. Salotti, IV and commonly assigned herewith.

### FIELD OF TIME INVENTION

The present invention is related to a novel graphical user interface for use in programming and configuring a machine control system and an iconic function sequencer used for ordering the execution of functional processes within the machine control system.

### BACKGROUND OF THE INVENTION

Machine control systems are well known in the art. Such systems include, for example, systems for controlling robotic assembly equipment such as pick and place (or placement) machines. A placement machine is a robotic instrument for picking up electronic and similar parts from component feeders and placing them at their assigned locations on a printed circuit board (PCB). Once all parts are placed, the PCB is placed in a reflow oven and solder paste disposed on the PCB melts forming permanent electrical connections between pads on the PCB and electrical contacts, leads or “pins” on the electrical components. The programming of placement machines can be complex. For example, one needs to instruct the placement machine to move a pick-up head to a particular component feeder pick-up location, operate the pick-up feeder to make available a part for pick-up, verify that the part is a correct part and available for pick-up, pick up the part, orient the part rotationally, possibly move the part to a station for an optional process, then move the part to an assigned location on the PCB, then precisely place the part within tight tolerances so that the proper pins of the part are in contact with mating pads of the PCB. These operations are often programmed with line-by-line instructions or by stepping the machine through the desired operation so that it can repeat the operation by rote. The line-by-line instruction method of programming requires skilled programmers, possibly extensive debugging, and can be tedious. The rote method of programming can be time consuming and result in non-optimal processing. Accordingly, a new method of programming machine control systems would be highly advantageous if it could be implemented without extensive training and provided an immediate feedback of how the machine had actually been programmed and could indicate to the programmer, or simply refuse, incorrect or sub-optimal programming steps.

### BRIEF DESCRIPTION OF THE INVENTION

A graphical user interface (GUI) includes a system configuration editor for configuring a machine control system and an iconic function sequencer for ordering the execution of functional processes within the machine control system. The system configuration editor graphically reflects how logical functions are connected to electrical functions within the physical machine system and permits a user to set up and alter those connections. Logical function blocks include one or more software program objects that perform logical functions such as dispensing a component in a pick and place machine control system. The system configuration editor permits configuring a logical function to use various electrical functions in performing its programmed function. For example, a user can electrically configure a logical dispensing function to turn on motor #3 and access output #2 from module #4 through graphical connections made between logical and electrical functions using the visual configuration editor. After the logical function blocks are configured in the machine control system, the iconic function sequencer permits a user to select the function blocks as tools and build a graphical representation of the sequence in which they will be performed. A user can click on and grab copies of each tool and connect compatible tools together in a building area on the screen, thus determining which logical functions will be performed and in what order they will be performed.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a schematic diagram of a pick and place machine control system with which the system configuration editor and iconic function sequencer may be applied in accordance with a specific embodiment of the present invention.

FIG. 2 is a pictorial diagram illustrating a graphical display of a system configuration editor in accordance with a specific embodiment of the present invention.

FIG. 3 is a pictorial diagram illustrating a graphical display of an iconic function sequencer of a system configuration editor in accordance with a specific embodiment of the present invention.

FIGS. 4 and 5 are screen-shots of a configuration editor in accordance with a specific embodiment of the present invention.

FIGS. 6, 7 and 8 are screen-shots of an iconic function sequencer in accordance with a specific embodiment of the present invention.

### DETAILED DESCRIPTION

Embodiments of the present invention are described herein in the context of a system configuration editor with an iconic function sequencer. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

System Configuration Editor

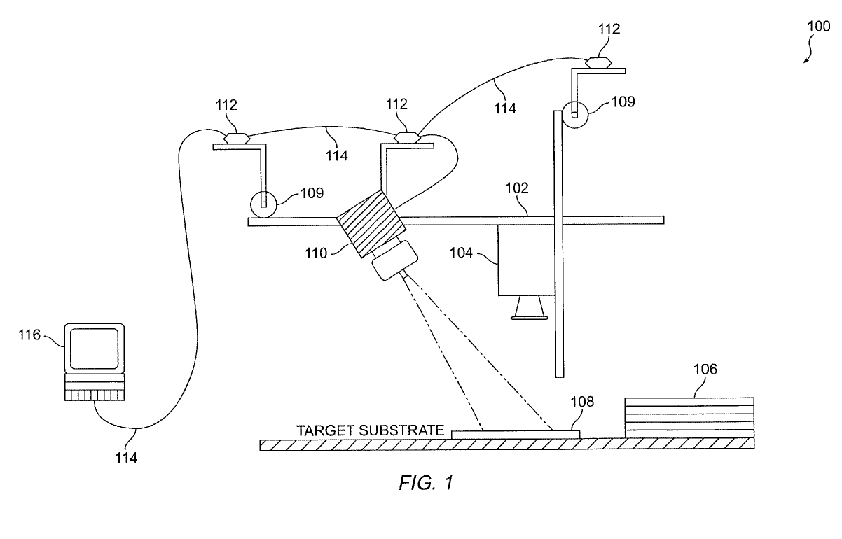

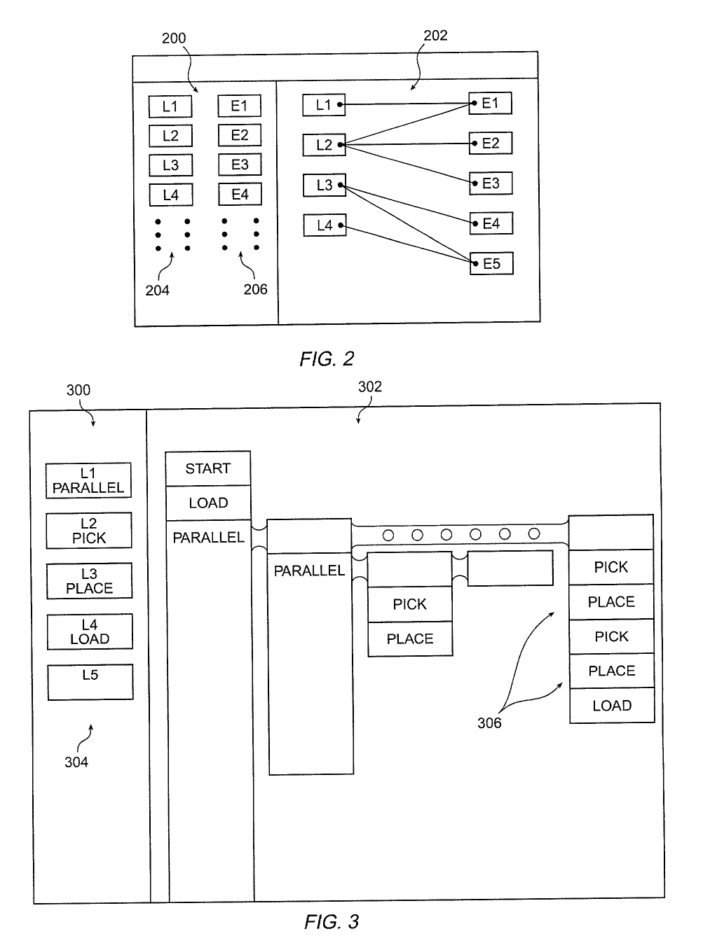

The present invention is represented in a specific embodiment as a system configuration editor in a graphical user interface (GUI) on the host computer 116 of a machine control system such as a placement machine 100 illustrated in FIG. 1. Those of ordinary skill in the art will now recognize that the system configuration editor is not limited to use in a host computer of a machine control system but can be used on any computer. The system configuration editor provides a user with a graphical representation of the electrical functions which correspond to each logical function that placement machine 100 performs. In addition, the system configuration editor allows the user to configure the electrical functions for each logical function to be performed by graphically wiring connections between logical function blocks and electrical function blocks as illustrated in FIG. 2.

The placement machine 100 of FIG. 1 is an example of a machine control system to which the system configuration editor of the present invention applies. Many other machines could also be used with this invention. Placement machine 100 has a pick-up head 102 transportable in X, Y, Z and T (rotational) directions which picks up components 104 (with a vacuum pick-up, gripper pick-up, or similar device) from component feeders 106 and transports them for placement onto a target substrate 108 such as a PCB. The components 104 in accordance with this example are typically electrical, electro-mechanical, or electro-optic components and generally require highly accurate placement onto the target substrate 108 due to typically densely packed input/output connections. Placement machine 100 generally has an imaging system 110 of some kind which observes the components 104 and the target substrate 108 in order to measure, register and align under-side contact and edge features of the components to corresponding target substrate features in order to achieve accurate placement. Placement machine 100 usually includes a number of motion control devices 112 for driving motors (also referred to as actuators) and sending and receiving digital and analog data. In addition, peripherals of placement machine 100 such as the imaging system 110, camera lighting (not shown), pick-up head 102 and vacuum generators (for use with vacuum pick-ups) may be wired to specific data input/output lines on the motion control devices 112.

In accordance with the present invention, the system configuration editor graphically displays the electrical connections between and within functional modules of a machine control system such as the motion control devices 112, imaging system 110, camera lighting, pick-up head 102 and vacuum generators of placement machine 100.

Referring to FIG. 2, a specific embodiment of the system configuration editor provides a function area 200 and a building area 202 on a divided screen. The function area 200 contains logical blocks 204 which correspond to logical functions that the machine control system performs. Each logical block 204 is associated with one or more underlying software program objects that outline steps to be performed by the logical block 204 and thereby define its function within the machine control system. The various types and numbers of logical blocks 204 within the function area 200 depend on the type and complexity of the given machine control system. In the case of placement machine 100 of FIG. 1, for example, these logical functions would include dispensing a component, picking up a component, placing a component, and so on. The function area 200 also contains electrical blocks 206 which correspond to electrical functions that are necessarily executed in a variety of ways within the machine control system whenever a logical function is performed by the system. For example, in the case of placement machine 100 of FIG. 1, the logical function of picking up a component might require that one or more motors be switched on, one of a number of component feeders 106 be accessed and specific data input/output lines on the motion control cards 112 be activated, each of which essentially requires that an electrical function be executed or an electrical connection be made within placement machine 100. The manner in which these electrical functions are configured for each particular logical function can vary greatly depending on the complexity of the machine control system.

The system configuration editor of the present invention provides a graphical user interface (GUI) that simplifies the task of configuring the logical and electrical functions of a machine control system. Referring again to FIG. 2, the system configuration editor allows a user to select any available logical block 204 that needs to be configured and transport a copy of that block onto the building area of the screen. Selection is accomplished by clicking on the logical block 204 icon and dragging a copy of the logical block 204 from the function area 200 of the screen to the building area 202 of the screen. In this manner, numerous logical blocks 204 and numerous electrical blocks 206 can be located in the building area 202 of the screen. The user can then graphically (using conventional click and drag GUI technology) pull a “wire” (representing a logical connection) from any logical block 204 to one or more electrical blocks 206 which effectively associates that particular logical block 204 with whatever electrical functions underlie the one or more electrical blocks 206 now connected with the particular logical block 204. The editor will also (because of its programming) prevent the establishment of such connections between logical blocks 204 and electrical blocks 206 whose underlying electrical functions are incompatible. With respect to the system configuration editor of the present invention, users may be more suitably described as system builders, since they are configuring the process by which each logical block will achieve its functional purpose within the machine control system.

After the logical blocks 204 are configured with the system configuration editor they become usable to a library of functions with which a user can command the machine control system to perform various jobs.

Iconic Function Sequencer

The iconic function sequencer of the present invention is illustrated in FIG. 3, and provides a function area 300 and a building area 302 on a divided screen. The function area 300 contains logical blocks 304 representative of the library of functions 204 in FIG. 2 previously configured using the system configuration editor. The user can select desired logical blocks 304 and transport them into the building area 302 of the screen in the same manner as described for the system configuration editor. The logical blocks 304 are connected together beginning toward the top of the screen and working toward the bottom of the screen such that their order from top to bottom depicts the order in which the machine control system is to perform the corresponding logical functions. The iconic function sequencer also permits logical blocks 304 to be placed in a horizontal manner across the building area 302 of the screen such that parallel groups of vertically configured logical blocks 306 can be performed concurrently.

Each logical block 304 has associative rules that prevent its connection with other logical blocks 304 that are incompatible. The blocks have graphical interfaces which behave like puzzle pieces that fit together only when they are compatible. Thus, the logical blocks 304 cannot be followed or preceded by blocks with corresponding incompatible functions. For example, an attempt to connect a place function in time before a pick function will not be permitted by the underlying software of the iconic function sequencer.

Furthermore, the underlying software of the logical blocks 304 make them graphically explodable (as by double-clicking a mouse when a cursor is positioned over the logical block in question) to reveal specific programmable properties corresponding to each logical block. The specific programmable properties related to each logical block 304 include such variables as electronic component types, electronic component values, which component feeder to select components from, speed of travel of the pick-up head, pick up location values and placement location values.

Operational Examples

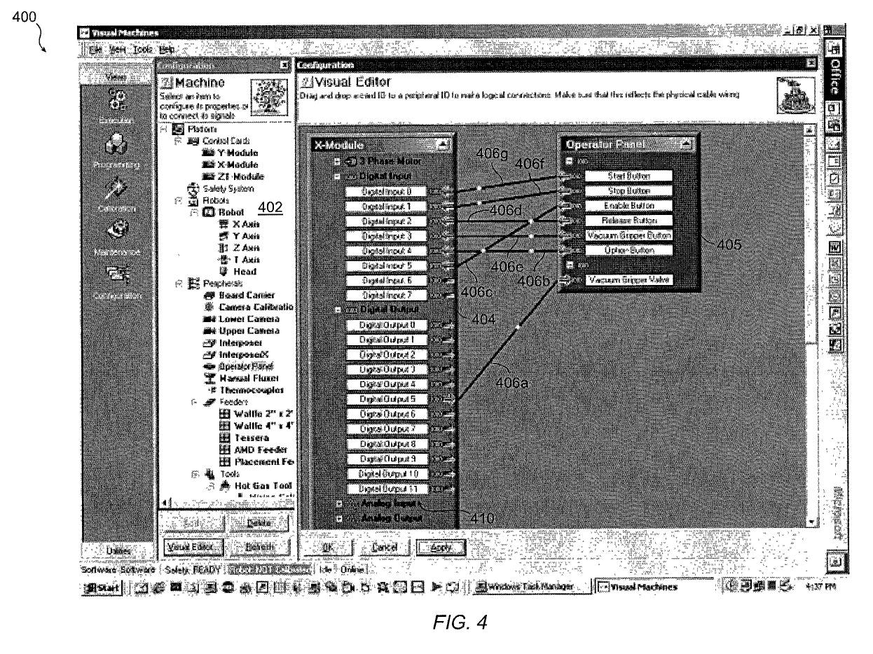

Turning now to FIG. 4, an actual configuration editor display screen 400 is shown operating on a Windows 2000 based personal computer. As can be seen in window 402, a “platform” which is a placement machine includes control cards (the X-module, the Y-module and the ZT-module) which carry out unidirectional and bi-directional communications with various peripheral devices such as user input buttons and X, Y, Z and T axis actuators. Also included are various other peripheral devices such as sensors, board carriers, component feeders, and the like. Window 404 is the X-module configuration screen. The particular X-module shown is a 3-phase motor controller having 8 digital input channels, 12 digital output channels and an analog input and an analog output channel. Those of ordinary skill in the art will now realize that any convenient configuration may be used. Using a mouse or similar GUI tool a user establishes links 406a-406f which reflect actual physical connections within the machine being configured. Thus a front panel button of an Operator Panel control cluster (window 405) labeled “START” happens to be wired to Digital Input 0 and provides unidirectional (button to digital input) signals over line 406g. Similarly Digital Output 5 is wired to Vacuum Gripper Valve and this is reflected with link 406a. The symbols in column 410 represent the electrical functions performed by each I/O element of the X-Module. Some of the symbols represent digital data flowing unidirectionally toward the X-Module (“1010” and arrow pointing toward X-Module), some represent unidirectional data flow from the X-Module toward the devices of the Operator Panel 405, others could (not shown here) represent bi-directional digital data, analog unidirectional or bi-directional data flow and other electrical concepts appropriate to the application.

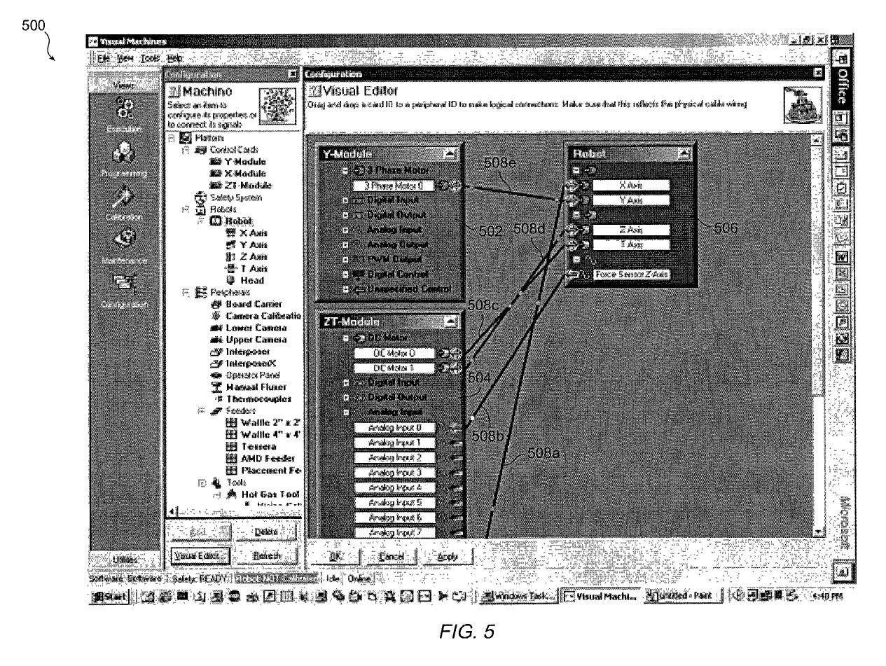

Turning now to FIG. 5 another actual configuration editor display screen 500 is shown. In screen 500 Y-module configuration screen 502, ZT-module configuration screen 504 and robot peripheral device configuration screen 506 are illustrated together with links 508a-508e. Thus, as can be seen, three-phase motor control I/O of the Y-module is coupled to the Y-axis actuator of the robotic assembly equipment via link 508e and Analog Input O of the ZT-module is coupled via link 508b to the Z-axis force sensor. As before, the links shown are configured to represent actual physical wired connections present in the machine being controlled. These are generally set up once at system installation and are modified if peripherals or connections are changed for some reason.

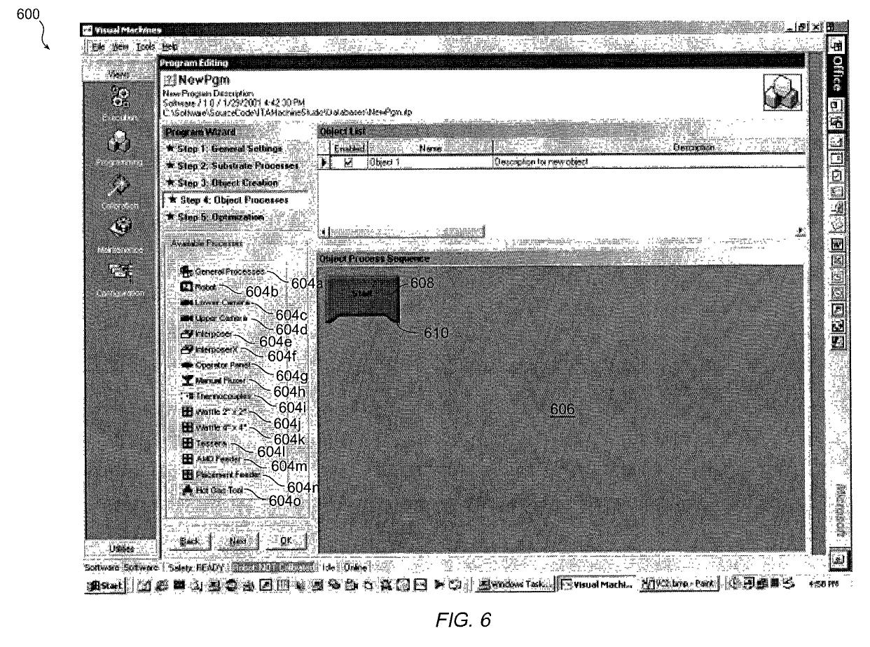

Turning now to FIG. 6, an actual iconic function sequencer programming screen 600 is shown. Window 602 contains iconic representations (and short titles as shown in this example) 604a-604o which represent various devices and processes such as general processes 604a, robot 604b, lower camera 604c, upper camera 604d, interposer 604e, interposerX 604f, Operator Panel 604g, Manual Fluxer 604h, Thermocouples 604i, various component feeder devices 604j-604n, and Hot Gas Tool 604o. Those of ordinary skill in the art will now realize that the line up of devices and processes will be machine specific depending upon the functions desired to be carried out by the machine and the options and peripheral equipment supplied with it. Window 606 represents a programming area where a user builds an iconic program. Block 608 labeled “START” is the beginning of the program. Blocks used for iconic programming have shaped edges 610 which fit other compatible edges of certain programming blocks but do not fit incompatible edges of other programming blocks. Thus if two processes are compatible, their respective iconic programming blocks will fit together jigsaw puzzle-wise and if they are incompatible, they cannot be made to fit together.

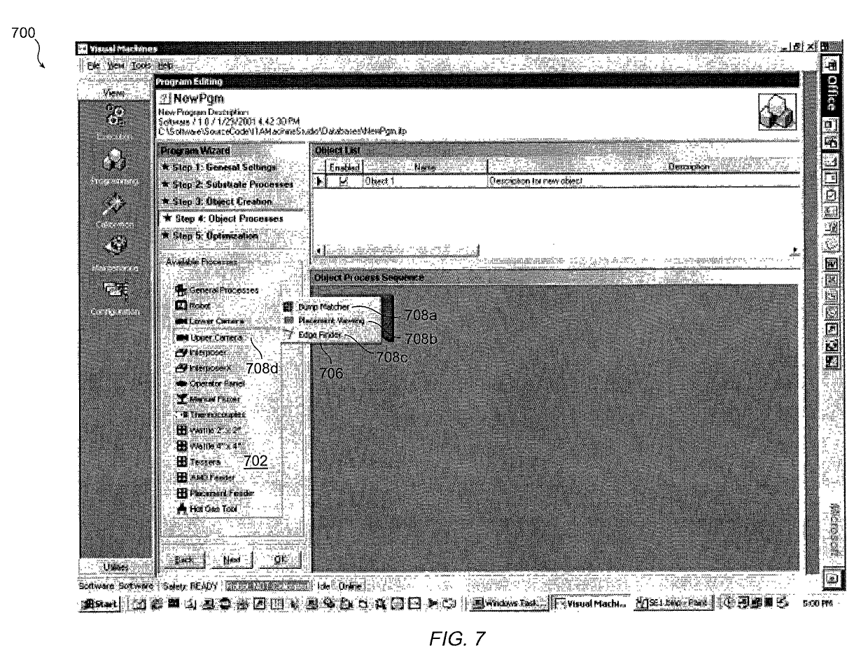

Turning now to FIG. 7 another screen-shot 700 of an actual iconic function sequencer programming screen is shown. Available categories of processes are listed in window 702 as described above for window 602. Clicking (as with a mouse or similar GUI control device) on a category of processes as here, Upper Camera 704d, causes another window 706 to be displayed. Window 706 contains a list of actual iconic program steps which may be programmed into the iconic program and which relate to the category 704d. Here window 706 lists Bump Matcher 708a, Placement Viewing 708b and Edge Finder 708c. By selecting Edge Finder 708c, the program block corresponding to that function is made available on the program window 606 and it can be moved around using conventional drag and drop technology and placed adjacent and locked to a compatible programming block.

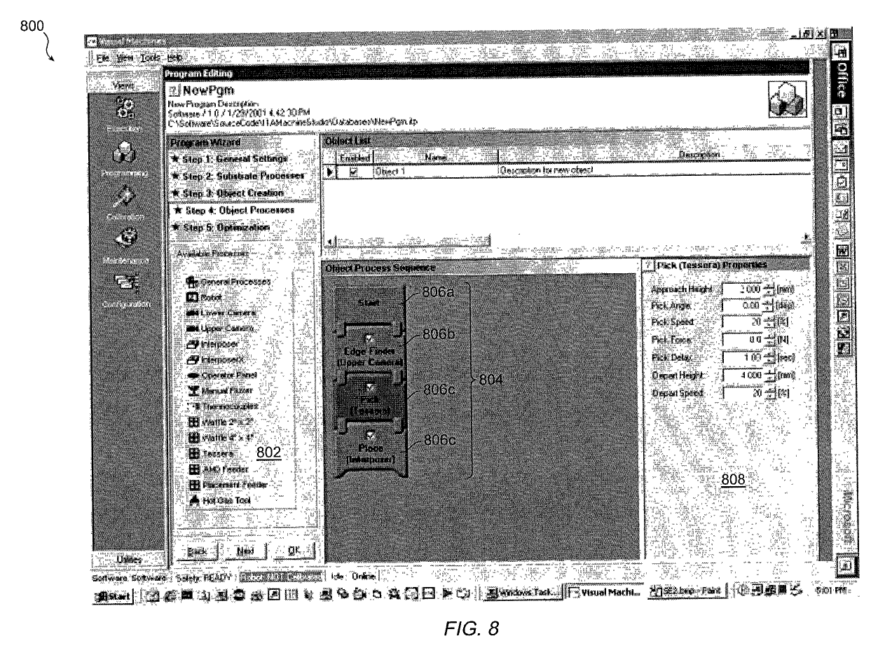

Turning now to FIG. 8, another screen-shot 800 of an actual iconic function sequencer programming screen is shown. Here a simple 4-step iconic program 804 is illustrated which includes START step 806a, EDGE FINDER step 806b, PICK step 806c and PLACE step 806d. The program flow begins at START and flows generally downward from there as illustrated graphically. Parallel or near-parallel processes are also supported where appropriate, e.g., an appropriate multi-pick head could pick up a number of components simultaneously if configured to do so, placement, however, would generally be a sequential process following such a parallel pick.

Clicking on, for example, the PLACE block 806d brings up window 808 which is a “properties” configuration window corresponding to that block. Individual properties may be tailor-fit to a specific application by modifying the various parameters set forth in the properties configuration window (here, approach height, pick angle, pick speed, pick force, pick delay, depart height and depart speed, but, of course, those of ordinary skill in the art will now realize that each block will have its own set of particular properties which correspond to it).

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for controlling a machine, the machine having at least one motion control device coupled to and controlling an actuator, said method comprising:
displaying a plurality of items in one area of a display screen, the items representing functions performable by the actuator;
selecting a first item from said plurality of items;
causing a first icon corresponding to said selected first item to be displayed in a second area of the display screen, a direction along said second area representing a chronologic sequence;
selecting a second item from said plurality of items;
causing a second icon corresponding to said selected second item to be displayed in said second area of the display screen; and
permitting said second icon to be positioned in contact with said first icon in said second area if said second item is chronologically sequentially compatible with said first item.

2. An apparatus for controlling a machine, the machine having at least one motion control device coupled to and controlling an actuator, said apparatus comprising:
means for displaying a plurality of items in one area of a display screen, the items representing functions performable by the actuator;
means for selecting a first item from said plurality of items;
means for causing a first icon corresponding to said selected first item to be displayed in a second area of the display screen, a direction along said second area representing a chronologic sequence;
means for selecting a second item from said plurality of items;
means for causing a second icon corresponding to said selected second item to be displayed in said second area of the display screen; and
means for permitting said second icon to be positioned in contact with said first icon in said second area if said second item is chronologically sequentially compatible with said first item.

3. A program storage device containing a program of instructions readable by a machine for performing a method, the method comprising:
displaying a plurality of items in one area of a display screen, the items representing functions performable by the actuator;
selecting a first item from said plurality of items;
causing a first icon corresponding to said selected first item to be displayed in a second area of the display screen, a direction along said second area representing a chronologic sequence;
selecting a second item from said plurality of items;
causing a second icon corresponding to said selected second item to be displayed in said second area of the display screen; and
permitting said second icon to be positioned in contact with said first icon in said second area if said second item is chronologically sequentially compatible with said first item.

4. A method for controlling a machine, the machine having at least one motion control device coupled to and controlling an actuator, the machine including a programmable controller having a display device, said method comprising:
displaying a representation of a plurality of I/O ports of the at least one motion control device on one area of the display device;
displaying a representation of an I/O port of the actuator on a second area of the display device; and
allowing a user to construct links graphically illustrated as lines coupling selected ones of said representations of said plurality of I/O ports of the at least one motion control device and said representation of an I/O port of the actuator, the links representing logical communications connections within the programmable controller.

5. An apparatus for controlling a machine, the machine having at least one motion control device coupled to and controlling an actuator, the machine including a programmable controller having a display device, said apparatus comprising:
means for displaying a representation of a plurality of I/O ports of the at least one motion control device on one area of the display device;
means for displaying a representation of an I/O port of the actuator on a second area of the display device; and
means for allowing a user to construct links graphically illustrated as lines coupling selected ones of said representations of said plurality of I/O ports of the at least one motion control device and said representation of an I/O port of the actuator, the links representing logical communications connections within the programmable controller.

6. A program storage device containing a program of instructions readable by a machine for performing a method, the method comprising:
displaying a representation of a plurality of I/O ports of the at least one motion control device on one area of the display device;
displaying a representation of an I/O port of the actuator on a second area of the display device; and
allowing a user to construct links graphically illustrated as lines coupling selected ones of said representations of said plurality of I/O ports of the at least one motion control device and said representation of an I/O port of the actuator, the links representing logical communications connections within the programmable controller.

7. A method for controlling a machine, the machine having at least one motion control device coupled to and controlling an actuator, the machine including a programmable controller having a display device, said method comprising:
displaying a representation of a plurality of I/O ports of the at least one motion control device on one area of the display device;
displaying port communication information relating to at least one of said plurality of I/O ports of the at least one motion control device;
displaying a representation of an I/O port of the actuator on a second area of the display device;
displaying port communication information relating to said I/O port of the actuator; and
allowing a user to construct links graphically illustrated as lines coupling selected ones of said representations of said plurality of I/O ports of the at least one motion control device and said representation of an I/O port of the actuator, the links representing logical communications connections within the programmable controller, the links only being constructible if the port communication information relating to said at least one of said plurality of I/O ports of the at least one motion control device is compatible with said port communication information relating to said I/O port of the actuator.

8. An apparatus for controlling a machine, the machine having at least one motion control device coupled to and controlling an actuator, the machine including a programmable controller having a display device, said apparatus comprising:
means for displaying a representation of a plurality of I/O ports of the at least one motion control device on one area of the display device;
means for displaying port communication information relating to at least one of said plurality of I/O ports of the at least one motion control device;
means for displaying a representation of an I/O port of the actuator on a second area of the display device;
means for displaying port communication information relating to said I/O port of the actuator; and
means for allowing a user to construct links graphically illustrated as lines coupling selected ones of said representations of said plurality of I/O ports of the at least one motion control device and said representation of an I/O port of the actuator, the links representing logical communications connections within the programmable controller, the links only being constructible if the port communication information relating to said at least one of said plurality of I/O ports of the at least one motion control device is compatible with said port communication information relating to said I/O port of the actuator.

9. A program storage device containing a program of instructions readable by a machine for performing a method, the method comprising:
displaying a representation of a plurality of I/O ports of the at least one motion control device on one area of the display device;
displaying port communication information relating to at least one of said plurality of I/O ports of the at least one motion control device;
displaying a representation of an I/O port of the actuator on a second area of the display device;
displaying port communication information relating to said I/O port of the actuator; and
allowing a user to construct links graphically illustrated as lines coupling selected ones of said representations of said plurality of I/O ports of the at least one motion control device and said representation of an I/O port of the actuator, the links representing logical communications connections within the programmable controller, the links only being constructible if the port communication information relating to said at least one of said plurality of I/O ports of the at least one motion control device is compatible with said port communication information relating to said I/O port of the actuator.

10. A machine control system, comprising:
at least one motion control device coupled to an actuator, the motion control device controlling the actuator;
a programmable controller for controlling the at least one motion control device;
a display device under control of the controller;
wherein the programmable controller causes said display device to display a plurality of items in one area of said display device, the items representing functions performable by the actuator and individually selectable by a user to cause a first icon corresponding to a first selected item to be displayed in a second area of said display device and a second icon corresponding to a second selected item to be displayed in said second area, a direction along said second area representing a chronologic sequence, and said second icon being positionable in contact with said first icon in said second area only if said second item is chronologically sequentially compatible with said first item.
